(19) United States
(12) Patent Application Publication
(10) Pub. No.: US 2016/0236209 A1
(43) Pub. Date: Aug. 18, 2016

(54) CENTRIFUGE

(71) Applicants: Craig STOUT, Port Matilda, PA (US); Kevin DEANGELO, Burlington, NC (US); Anthony J. HENDERSON, State College, PA (US)

(72) Inventors: Craig STOUT, Port Matilda, PA (US); Kevin DEANGELO, Burlington, NC (US); Anthony J. HENDERSON, State College, PA (US)

(21) Appl. No.: 14/623,110

(22) Filed: Feb. 16, 2015

(51) Int. Cl. B04B 7/08; B04B 15/00

(52) U.S. Cl. CPC B04B 7/08; B04B 15/00

(57) ABSTRACT

A centrifuge including a first portion having a first end opposite a second end, the first portion positioned substantially vertically above a second portion. The first portion having a rotor for receiving at least one specimen holder insertable in the rotor from a position vertically above the rotor. The second portion raises the first end of the first portion relative to the second end of the first portion with respect to a horizontal plane coincident with an upper segment of the second end for permitting viewing of at least a fraction of the rotor associated with the at least one specimen holder from a vantage point near the second end and vertically positioned above or at least about coincident with the horizontal plane.

### BACKGROUND

The present invention is directed to a centrifuge.

Centrifuges are commonly used in medical and biological research for separating purifying materials of different densities such as viruses, bacteria, sales, proteins, and other compositions. A centrifuge normally includes a motor, a rotor and specimen holders capable of spinning up to tens of thousands of revolutions per minute. Specimen holders include, for example, test tubes, test tube holders, or any other means suitable for retaining a specimen.

There are challenges associated with use of centrifuges in laboratory or lab environments. Centrifuges are placed on lab countertops that are approximately three feet tall and are usually positioned approximately one foot from the edge of the lab countertop. The centrifuge is approximately one foot tall. Many centrifuge operators are little more than five feet tall. As a result of their lower vantage point, and without assistance, these operators may be unable to see into the centrifuge to confirm that all samples have been removed, to ensure samples have been loaded properly, or to confirm that it is safe to reach into the rotor chamber where the rotor could potentially be rotating or tubes or specimen holders may have broken, spilled or been dropped to the bottom of the chamber.

In addition, lab countertop space is extremely scarce and, therefore highly valuable. In many small labs, the centrifuge is only used a few times per day, but still requires a minimum of one square foot of counter space plus clearance around the centrifuge.

It would be desirable in the art to have a centrifuge that does not suffer from the above-mentioned drawbacks.

### SUMMARY

One embodiment of the disclosure is directed to a centrifuge including a first portion having a first end opposite a second end, the first portion positioned substantially vertically above a second portion. The first portion having a rotor for receiving at least one specimen holder insertable in the rotor from a position vertically above the rotor. The second portion raises the first end of the first portion relative to the second end of the first portion with respect to a horizontal plane coincident with an upper segment of the second end for permitting viewing of at least a fraction of the rotor associated with the at least one specimen holder from a vantage point near the second end and vertically positioned above or at least about coincident with the horizontal plane.

Another embodiment of the disclosure is directed to a centrifuge including a first portion having a first end opposite a second end, the first portion positioned substantially vertically above a second portion. The first portion having a rotor for receiving at least one specimen holder insertable in the rotor from a position vertically above the rotor. The second portion raises the first end of the first portion relative to the second end of the first portion with respect to a horizontal plane coincident with an upper segment of the second end for permitting viewing of at least a fraction of the rotor associated with the at least one specimen holder from a vantage point near the second end and vertically positioned above or at least about coincident with the horizontal plane. Centrifuge controls associated with a surface of at least one of the first portion and second portion adjacent the second end each have a corresponding coincident line that is coincident with a plane perpendicular to the horizontal plane, the at least one coincident line and the horizontal plane subtends an angle that is less than or about equal to 90 degrees from the horizontal plane.

Yet another embodiment of the disclosure is directed to a centrifuge including a first portion having a first end opposite a second end, the first portion positioned substantially vertically above a second portion. The first portion having a rotor for receiving at least one specimen holder insertable in the rotor from a position vertically above the rotor. The second portion raises the first end of the first portion relative to the second end of the first portion with respect to a horizontal plane coincident with an upper segment of the second end for permitting viewing of at least a fraction of the rotor associated with the at least one specimen holder from a vantage point near the second end and vertically positioned above or at least about coincident with the horizontal plane. An angle subtending between the horizontal plane and a line substantially coincident with the upper segment of the second end of the first portion is between about 10 degrees and about 30 degrees.

### BRIEF DESCRIPTION OF THE FIGURES

FIG. 1 shows an upper isometric view of an exemplary embodiment of a centrifuge.

FIGS. 2-3 show respective upper and lower isometric views of an exemplary embodiment of a stand for a centrifuge.

FIGS. 4-8 show respective orthogonal views of an exemplary embodiment of a stand for a centrifuge.

FIG. 9 shows an upper isometric view of an exemplary embodiment of a centrifuge.

FIG. 10 shows an elevation view of the an exemplary embodiment of the centrifuge of FIG. 9.

FIG. 11 shows comparative respective side-by-side upper isometric views of a known art centrifuge and an exemplary embodiment of a centrifuge of the present disclosure.

FIG. 12 shows an upper isometric view of an embodiment of a centrifuge arranged inside of a cabinet.

### DETAILED DESCRIPTION OF EXEMPLARY EMBODIMENTS

Exemplary embodiments are directed to a centrifuge that overcomes drawbacks associated with conventional centrifuges. While discussed in the context of a particular centrifuge, it will be appreciated that all of the aspects of that centrifuge are not required to be used in combination. Rather, any one of the components or subassemblies can be separately employed in conjunction with otherwise conventional centrifuges or otherwise combined in any manner desired.

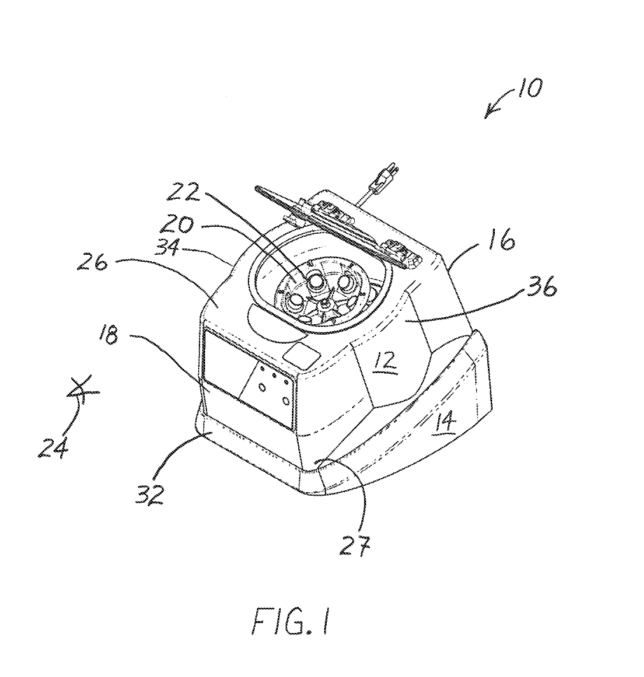

As shown in FIG. 1, a centrifuge 10 of the present disclosure comprises a first portion 12 positioned substantially vertically above and supported by a second portion 14. First portion 12 has a first end 16 opposite a second end 18 and a rotor 20 for receiving a plurality of specimen holders 22 accessible from a position vertically above rotor 20. As a result of the novel construction of second portion 14, first end 16 of first portion 12 is raised relative to second end 18 of first portion 12. This arrangement permits viewing of at least a fraction of rotor 20 associated with at least one specimen holder 22 from a vantage point 24 near second end 18 that is vertically positioned above or at least about coincident with an upper segment 26 of second end 18, as will be discussed in additional detail below.

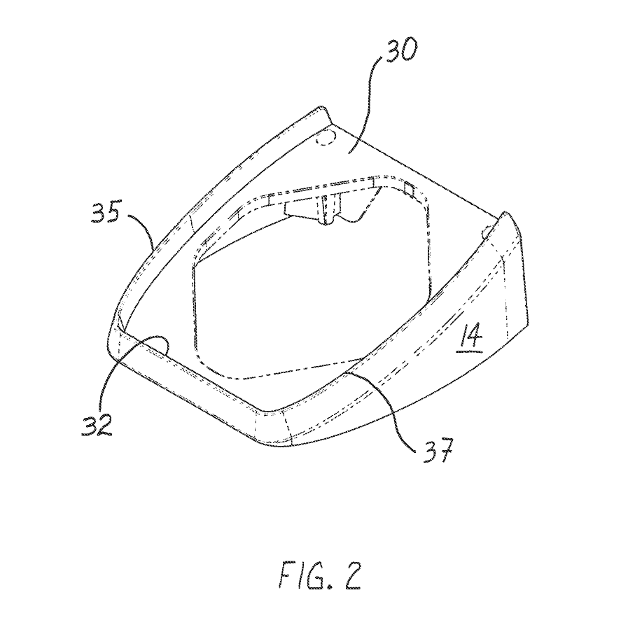

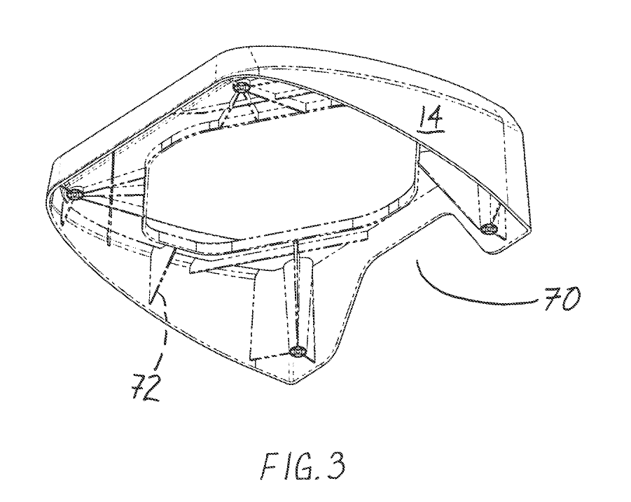

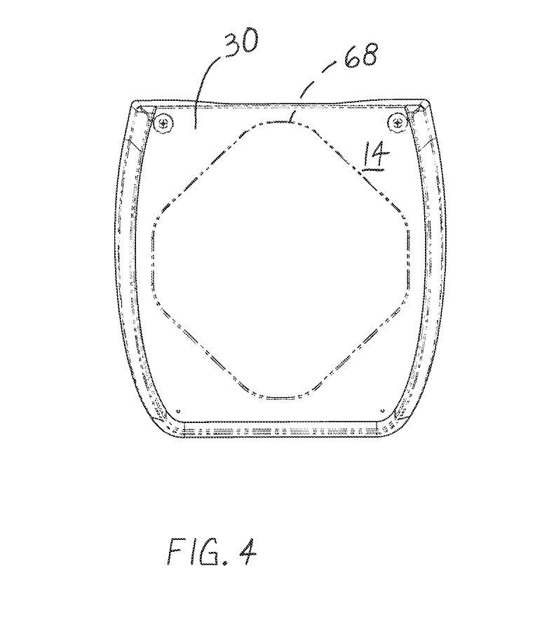

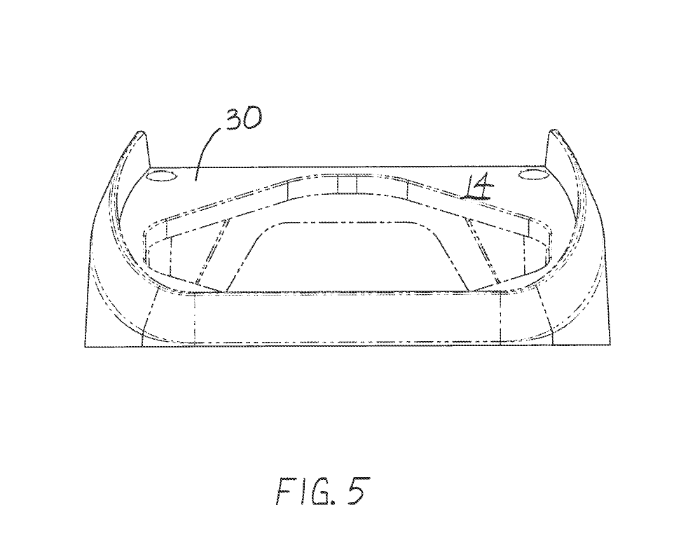

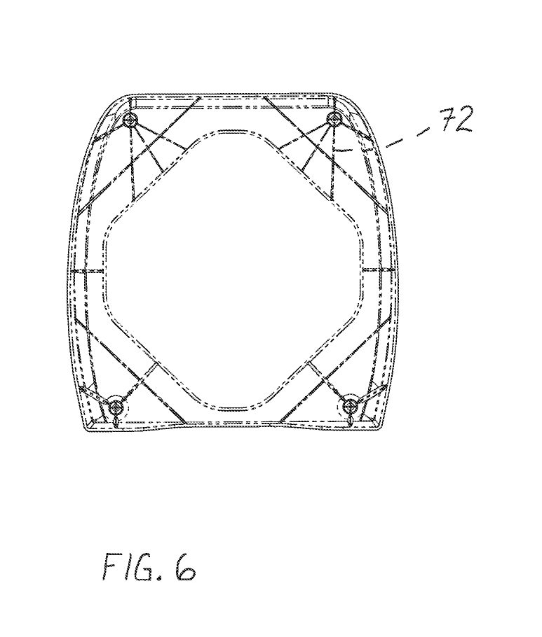

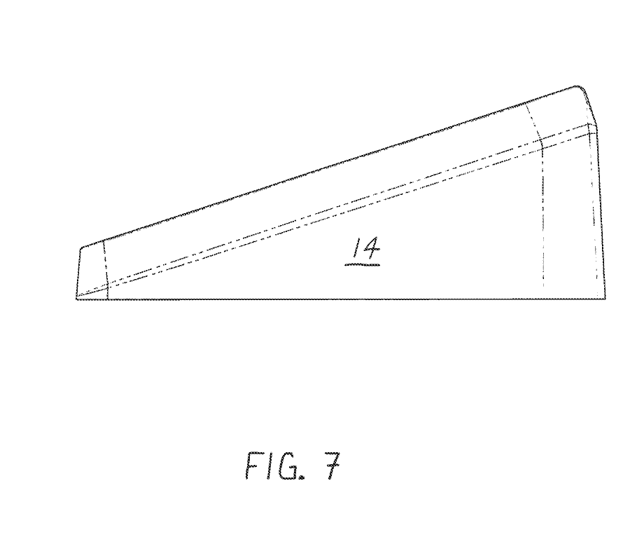

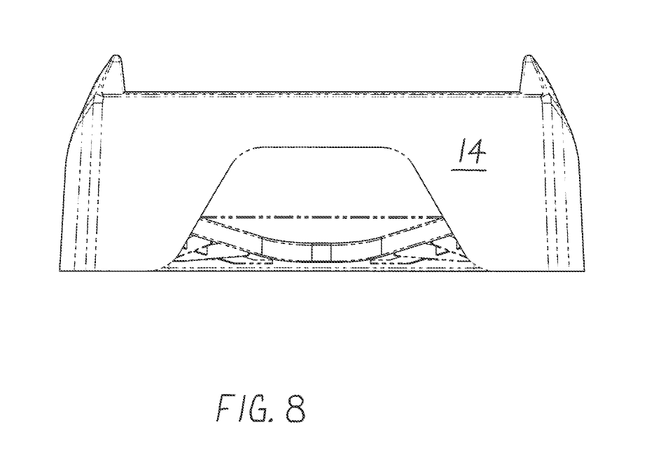

As shown in FIGS. 2-8, second portion 14 includes a body 28 having a support surface 30 for supporting first portion 12 (FIG. 1). In one embodiment support surface 30 is smooth to securely engage a lower segment 27 (FIG. 1) having suction cups (not shown) extending downwardly from lower segment 27 of first portion 12. As further shown in FIG. 2, a protrusion 32 extends outwardly from second portion 14 toward the first portion 12 when second portion 14 and first portion 12 are brought together to help support/secure first portion 12 to second portion 14. Optionally, openings 68, 70 as well as webs 72 or other reinforcement features may be formed in first portion 12. In one embodiment, protrusion 32 corresponds to or is adjacent to at least a portion of lower segment 27 (FIG. 1) of second end 18. In another embodiment, one or more of protrusions 35, 37 extend outwardly toward corresponding ends 34, 36 (FIG. 1) of lower segment 27 of first portion 12 that are adjacent to second end 18 of first portion 12. As further shown in FIG. 2, protrusions 32, 35, 37 are interconnected. In another embodiment, the protrusions are not connected to each other. In another embodiment, the protrusions can form a contiguous periphery extending outwardly from support surface 30. In one embodiment, first portion 12 and second portion 14 form an integral or unitary (one piece) housing of the centrifuge. In another embodiment, first portion 12 is structurally supported by second portion 14 with fasteners (not shown). In another embodiment, first portion 12 is structurally supported/secured by second portion 14 without fasteners, such as by gravity and friction between contact surfaces of the first portion and the second portion.

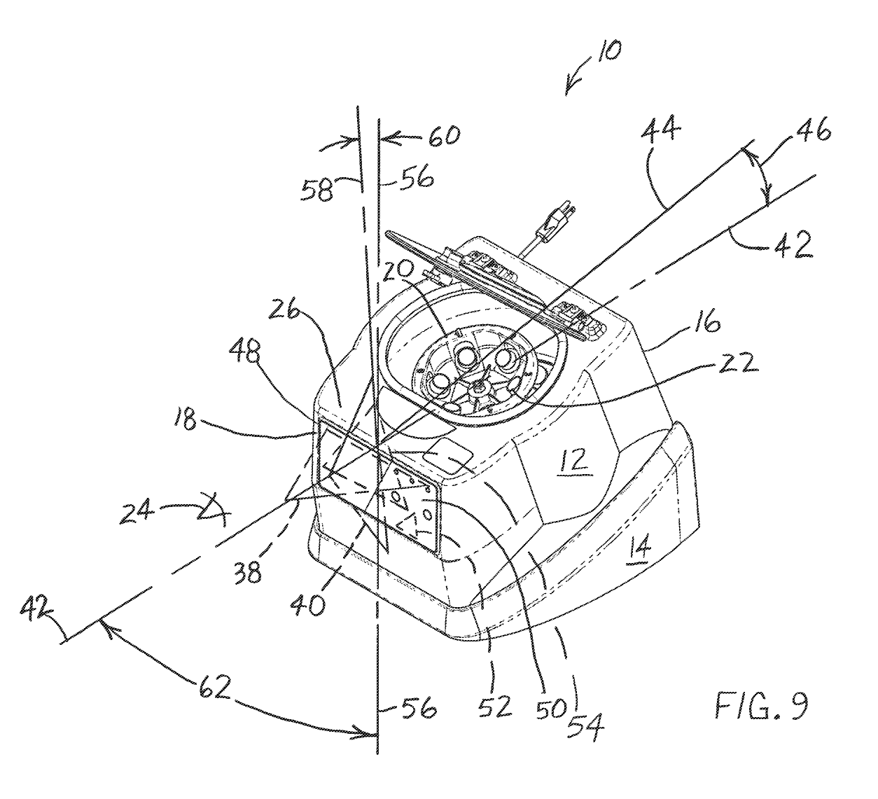

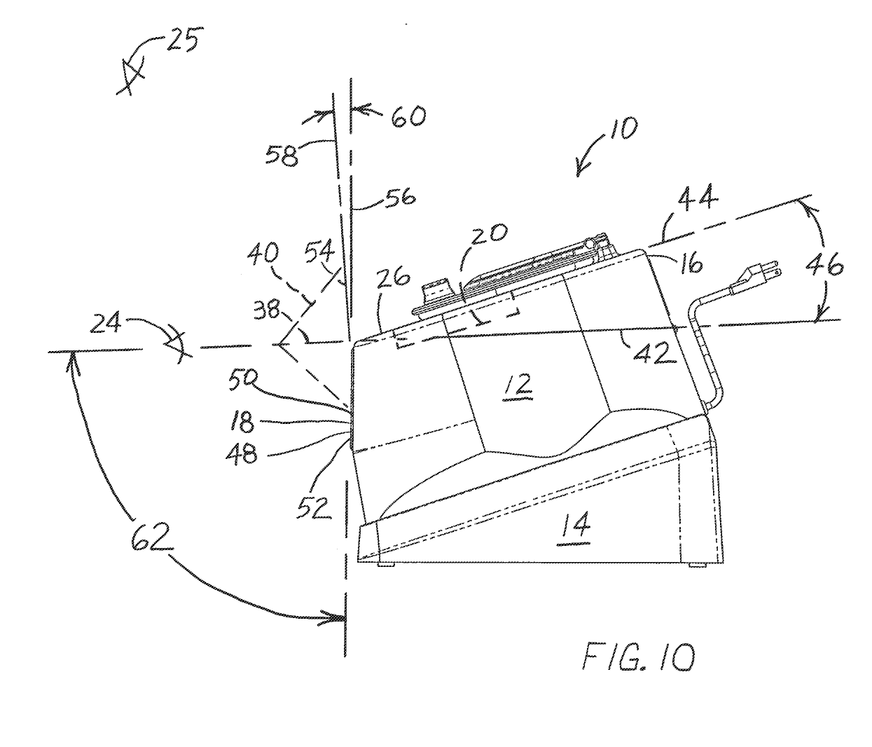

FIGS. 9-10 show an upper isometric view and a respective elevation view of centrifuge 10 for purposes of clarifying the disclosure. As best shown in FIG. 9, positioned along upper segment 26 of second end 18 is a horizontal plane 38 and a vertical plane 40 intersecting along a line 42. As further shown in FIG. 9, a line 44 that extends along and is substantially coincident with upper segment 26 and is also coincident with vertical plane 40 subtends an angle 46 between lines 42 and line 44.

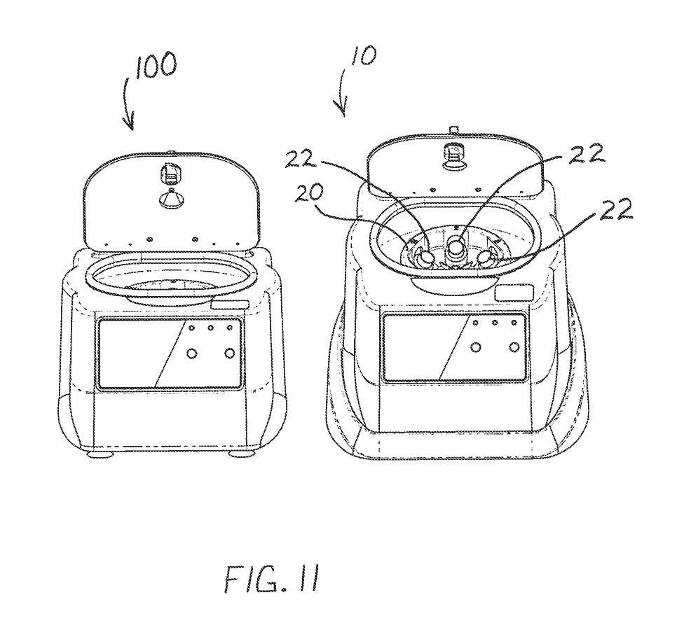

By virtue of angle 46, from vantage point 24 positioned near second end 18 and further vertically positioned above or at least about coincident with horizontal plane 38, viewing is permitted of at least a fraction of rotor 20 associated with at least one specimen holder 22. As a result of this permitted partial viewing of rotor 20 and at least one specimen holder 22, operators having vantage point 24 are able to view the rotor and at least one specimen holder to confirm that samples have been removed, to ensure samples have been loaded properly, or to confirm that it is safe to reach into the rotor chamber where the rotor could potentially be rotating or tubes or specimen holders may have broken, spilled or been dropped to the bottom of the chamber. As shown in FIG. 11, from a common vantage point, centrifuge 10 of the present disclosure permits full viewing of multiple specimen holders, while a centrifuge 100, that is positioned side-by-side to centrifuge 10, fails to permit full viewing of any specimen holders.

As further shown in FIGS. 9-10, first portion 12 includes centrifuge controls 48 positioned along end 18, such as a control panel for controlling operation of the centrifuge, which centrifuge controls 48 are associated with a surface 50, such as a surface substantially coincident with a plane 52. In one embodiment, the centrifuge controls may be positioned along end 18 of second portion 14. A second vertical plane 54 is mutually perpendicular to both horizontal plane 38 and vertical plane 40. A line 56 is coincident with vertical plane 40 and surface 50 associated with centrifuge controls 48. A line 58 is coincident with vertical plane 40 and second vertical plane 54. Line 56 and line 58 subtend an angle 60 therebetween. Line 56 and horizontal plane 38 subtend an angle 62 therebetween.

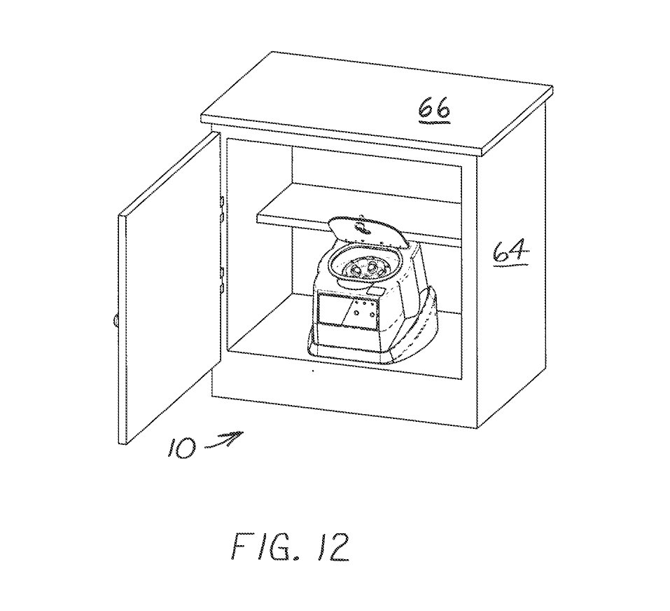

As further shown in FIGS. 9-10, the magnitude of angle 46 is generally related to the magnitude of angle 62. That is, while on one hand it is generally desirable to maximize the magnitude of angle 46 for improved viewability of the rotor and specimen holders, it is also generally desirable that the resulting angle 62 (the angle between surface 50 of centrifuge controls 48 (line 56) and horizontal plane 38) be less than or about equal to 90 degrees. Stated another way, subtracting angle 60 from 90 degrees equals angle 62. Angle 62 is associated with viewability of centrifuge controls 48 from a vantage point 25 (FIG. 10) significantly vertically greater than the vertical position of the centrifuge controls. For example, as shown in FIG. 12, in which the centrifuge is positioned inside a cabinet 64 beneath a countertop 66, it is appreciated that increasing angle 62 to a magnitude greater than 90 degrees (FIGS. 9-10) would result in decreased viewability of the centrifuge controls, possibly requiring an operator to lower their vantage point (bend over, kneel, etc.) in order to view the centrifuge controls.

It is to be further understood by one having ordinary skill in the art that the depth of the rotor within the rotor chamber, the shape of the opening to the rotor chamber, the geometry of the centrifuge housing (for example, the angle from a vertical plane between the surface of centrifuge controls without the second portion) as well as potential constraints imposed by rotors having fixed openings to receive specimen holders, may limit the magnitude of angle 46 (FIG. 9) between opposed ends of the upper segment of the centrifuge. In one embodiment, angle 46 is between about 10 degrees and about 30 degrees, about 12 degrees and about 28 degrees, about 14 degrees and about 26 degrees, about 15 degrees and about 24 degrees, about 15 degrees and about 22 degrees, about 16 degrees and about 20 degrees, about 17 degrees and about 19 degrees, about 11 degrees, about 12 degrees, about 13 degrees, about 14 degrees, about 15 degrees, about 16 degrees, about 17 degrees, about 18 degrees, about 19 degrees, about 20 degrees, about 21 degrees, about 22 degrees, about 23 degrees, about 24 degrees, about 25 degrees, about 26 degrees, about 27 degrees, about 28 degrees, about 29 degrees, about 30 degrees, or any combination or sub combination thereof.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A centrifuge comprising:
a first portion having a first end opposite a second end, the first portion positioned substantially vertically above a second portion; and
the first portion having a rotor for receiving at least one specimen holder insertable in the rotor from a position vertically above the rotor;
wherein the second portion raises the first end of the first portion relative to the second end of the first portion with respect to a horizontal plane coincident with an upper segment of the second end for permitting viewing of at least a fraction of the rotor associated with the at least one specimen holder from a vantage point near the second end and vertically positioned above or at least about coincident with the horizontal plane.

2. The centrifuge of claim 1, wherein an angle subtending between the horizontal plane and a line substantially coincident with the upper segment of the second end of the first portion is between about 10 degrees and about 30 degrees.

3. The centrifuge of claim 2, wherein the angle is about 18 degrees.

4. The centrifuge of claim 1, wherein centrifuge controls associated with a surface of at least one of the first portion and second portion adjacent the second end each have a corresponding coincident line that is coincident with a plane perpendicular to the horizontal plane, the at least one coincident line and the horizontal plane subtends an angle that is less than or about equal to 90 degrees from the horizontal plane.

5. The centrifuge of claim 4, wherein the angle is equal to 90 degrees from the horizontal plane.

6. The centrifuge of claim 1, wherein the first portion and the second portion form an integral housing of the centrifuge.

7. The centrifuge of claim 1, wherein the second portion includes a protrusion extending outwardly from the second portion toward the first portion.

8. The centrifuge of claim 7, wherein at least a portion of the protrusion is adjacent to at least portion of the second end of the first portion.

9. The centrifuge of claim 1, wherein the second portion is composed of a polymer.

10. The centrifuge of claim 9, wherein the polymer is a molded polymer.

11. A centrifuge comprising:
a first portion having a first end opposite a second end, the first portion positioned substantially vertically above a second portion; and
the first portion having a rotor for receiving at least one specimen holder insertable in the rotor from a position vertically above the rotor;
wherein the second portion raises the first end of the first portion relative to the second end of the first portion with respect to a horizontal plane coincident with an upper segment of the second end for permitting viewing of at least a fraction of the rotor associated with the at least one specimen holder from a vantage point near the second end and vertically positioned above or at least about coincident with the horizontal plane;
wherein centrifuge controls associated with a surface of at least one of the first portion and second portion adjacent the second end each have a corresponding coincident line that is coincident with a plane perpendicular to the horizontal plane, the at least one coincident line and the horizontal plane subtends an angle that is less than or about equal to 90 degrees from the horizontal plane.

12. The centrifuge of claim 11, wherein an angle subtending between the horizontal plane and a line coincident with the upper segment of the second end of the first portion is between about 10 degrees and about 30 degrees.

13. The centrifuge of claim 12, wherein the angle is about 18 degrees.

14. A centrifuge comprising:
a first portion having a first end opposite a second end, the first portion positioned substantially vertically above a second portion; and
the first portion having a rotor for receiving at least one specimen holder insertable in the rotor from a position vertically above the rotor;
wherein the second portion raises the first end of the first portion relative to the second end of the first portion with respect to a horizontal plane coincident with an upper segment of the second end for permitting viewing of at least a fraction of the rotor associated with the at least one specimen holder from a vantage point near the second end and vertically positioned above or at least about coincident with the horizontal plane;
wherein an angle subtending between the horizontal plane and a line substantially coincident with the upper segment of the second end of the first portion is between about 10 degrees and about 30 degrees.

15. The centrifuge of claim 14, wherein the angle is about 18 degrees.

16. The centrifuge of claim 14, wherein centrifuge controls associated with a surface of at least one of the first portion and second portion adjacent the second end each have a corresponding coincident line that is coincident with a plane perpendicular to the horizontal plane, the at least one coincident line and the horizontal plane subtends an angle that is less than or about equal to 90 degrees from the horizontal plane.
